(19) United States
(12) Patent Application Publication
(10) Pub. No.: US 2024/0035879 A1
(43) Pub. Date: Feb. 1, 2024

(54) VIBRATION DETECTOR, SOUND WAVE DETECTOR, MICROPHONE, AND WEARABLE DEVICE

(71) Applicant: Mitsuhiro Yoda, Tokyo (JP)

(72) Inventor: Mitsuhiro Yoda, Tokyo (JP)

(73) Assignee: Ricoh Company, Ltd., Tokyo (JP)

(21) Appl. No.: 18/357,429

(22) Filed: Jul. 24, 2023

(30) Foreign Application Priority Data
Jul. 26, 2022 (JP) 2022-119016

(51) Int. Cl. G01H 11/08

(52) U.S. Cl. CPC G01H 11/08; H04R 1/08

(57) ABSTRACT

A vibration detector includes: a vibration member to vibrate in a thickness direction; a fixed end beam member connected to the vibration member at one end of the fixed end beam member in a first direction; a fixed member connected to another end of the fixed end beam member in the first direction; and a strain detection member on at least one of the fixed end beam member or the vibration member and to detect strain of the vibration member. A length of the one end in a second direction perpendicular to the first direction and the thickness direction is shorter than a length of one side of the vibration member in the second direction, the one side of the vibration member is opposed to the fixed member in the first direction.

### CROSS-REFERENCE TO RELATED APPLICATIONS

This patent application is based on and claims priority pursuant to 35 U.S.C. § 119(a) to Japanese Patent Application No. 2022-119016, filed on Jul. 26, 2022, in the Japan Patent Office, the entire disclosure of which is hereby incorporated by reference herein.

### BACKGROUND

### Technical Field

The present disclosure relates to a vibration detector, a sound wave detector, a microphone, and a wearable device.

### Related Art

For the purpose of reducing noise and increasing low frequency sensitivity, a sound transducer (micro electromechanical system (MEMS) transducer) including multiple tapered vibration beams separated by a predetermined gap is known.

### SUMMARY

A vibration detector includes: a vibration member to vibrate in a thickness direction; a fixed end beam member connected to the vibration member at one end of the fixed end beam member in a first direction; a fixed member connected to another end of the fixed end beam member in the first direction; and a strain detection member on at least one of the fixed end beam member or the vibration member and to detect strain of the vibration member. A length of the one end in a second direction perpendicular to the first direction and the thickness direction is shorter than a length of one side of the vibration member in the second direction, the one side of the vibration member is opposed to the fixed member in the first direction.

Further, an embodiment of the present disclosure provides a sound wave detector comprising the vibration detector described above.

Further, an embodiment of the present disclosure provides a microphone comprising the vibration detector described above.

Further, an embodiment of the present disclosure provides a wearable device comprising the vibration detector described above.

Further, an embodiment of the present disclosure provides a vibration detector including: a vibration member to vibrate in a thickness direction; a fixed end beam member connected to the vibration member at one end of the fixed end beam member in a first direction; a fixed member connected to another end of the fixed end beam member in the first direction; and a strain detection member on at least one of the fixed end beam member or the vibration member and to detect strain of the vibration member. A length of the another end in a second direction perpendicular to the first direction and the thickness direction is shorter than a length of one side of the vibration member in the second direction, the one side of the vibration member is opposed to the fixed member in the first direction.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram of an example of the vibration principle of a piezoelectric microphone:

FIG. 2 is a partial plan view of a piezoelectric microphone according to the first embodiment;

FIG. 3 is a plan view of the piezoelectric microphone according to the first embodiment;

FIG. 4 is a side view of the piezoelectric microphone according to the first embodiment;

FIG. 5 is a diagram of strain distribution on a vibration member and fixed end beam members according to the first embodiment;

FIG. 6 is a diagram of a configuration for a detection electrode wiring according to the first embodiment;

FIG. 7 is a diagram of the piezoresistance arrangement according to the first embodiment;

FIG. 8 is a partial plan view of the piezoelectric microphone according to the second embodiment;

FIG. 9 is a plan view of the piezoelectric microphone according to the second embodiment;

FIG. 10 is a diagram of a shape modification of the vibration member;

FIG. 11 is a diagram of a first modification of the fixed end beam member;

FIG. 12 is a diagram of a second modification of the fixed end beam member;

FIG. 13 is a diagram of another modification of the fixed end beam member;

FIG. 14A is a diagram of a shape modification of the vibration member and the arrangement of the strain detection member, in which four strain detection members are arranged at the same coordinate in the X-direction;

FIG. 14B is a diagram of a shape modification of the vibration member and the arrangement of the strain detection member, in which four strain detection members are arranged in the same coordinates in the X-direction and Y-direction;

FIG. 14C is a diagram a shape modification of the vibration member and the arrangement of the strain detection member, in which two strain detection members are staggered in the X-direction with respect to the arrangement in FIG. 14A;

FIG. 14D is a diagram of a shape modification of the vibration member and the arrangement of the strain detection member, in which two strain detection members are disposed on one vibration member;

FIG. 15 is a diagram of a comparative example of a vibration principle of a typical electrostatic capacitive microphone;

FIG. 16A is a diagram of a comparative example of a cross section of a typical electrostatic capacitive microphone;

FIG. 16B is an exterior image of a comparative example of a typical electrostatic capacitive microphone;

FIG. 17 is a diagram of a sound wave detector;

FIG. 18 is a diagram of a wearable device; and

FIG. 19 is a diagram of another wearable device.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to the embodiments of the present invention, a vibration detector, a sound wave detector, a microphone, and a wearable device having a high sensitivity in the low frequency region can be provided.

Embodiments of the present disclosure will be described with reference to the drawings. In the description of the drawings, the same components are denoted by the same reference numerals, and overlapping description will be omitted.

### First Embodiment

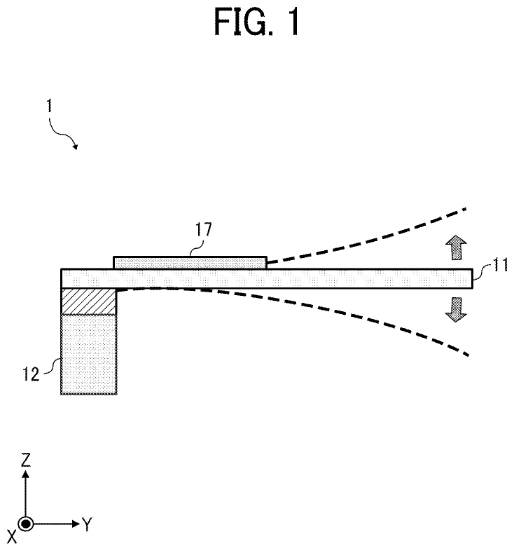

A first embodiment will be described with reference to FIGS. 1 to 7, FIGS. 15 and 16.

### Vibration Principle of Typical Electrostatic Capacitive Microphone

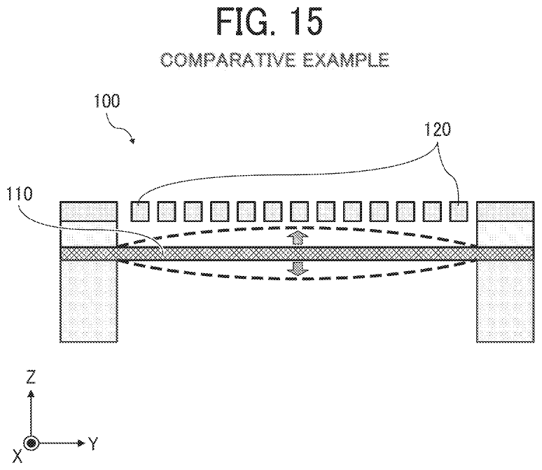

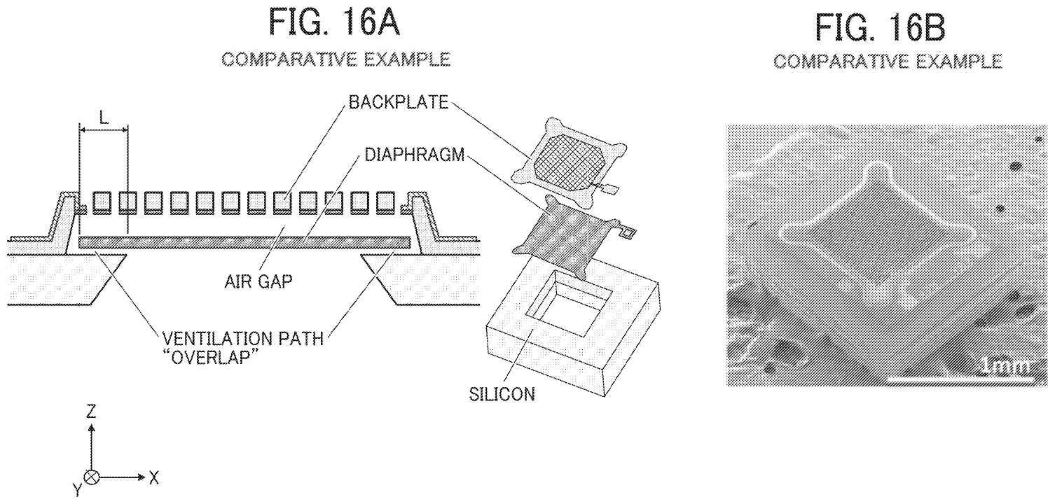

FIG. 15 is a diagram of the vibration principle of a typical electrostatic capacitive microphone as a comparative example. FIG. 16A is a diagram of a cross section of a typical electrostatic capacitive microphone as a comparative example, in which the movable electrode 110 and the fixed electrode 120 described above are formed on silicon so as to be superposed on each other. FIG. 16B is an external image of a typical electrostatic capacitive microphone as a comparative example.

A electrostatic capacitive microphone is used, for example, in a smartphone. As illustrated in FIG. 15, the electrostatic capacitive microphone 100 includes the parallel plate electrode of the movable electrode 110 and the fixed electrode 120 which receives a sound wave as an example of a vibration source. A electrostatic capacitive microphone 100 detects an electromotive force generated by a change in electrostatic capacitance between the parallel plate electrode caused by vibration of the movable electrode 110, which detects a displacement amount of the movable electrode 110, and converts a sound wave into an electrical signal. At this time, the fixed electrode 120 functions as both a slit and an electrode. Since the electrostatic capacitive microphone 100 has a high sensitivity and low noise characteristics (noise floor), the signal-to-noise ratio (S/N ratio) is high and excellent frequency characteristics are exhibited. Thus, the electrostatic capacitive microphone 100 is common in a microphone at present. Further, since the electrostatic capacitive microphone 100 has an advantageous configuration for increasing the sensitivity of the device by reducing the distance between the electrodes, the distance between the electrodes has been reduced to about 1 μm in recent years.

On the other hand, since the distance between the electrodes is small, and the diaphragm collides with the counter electrode when the displacement of the diaphragm becomes large, the resonance frequency cannot be designed to be low (sensitivity on the low frequency band cannot be increased) in the electrostatic capacitive microphone 100. In addition, the electrostatic capacitive microphone 100 uses an input power supply for charging by applying a constant electric field between the parallel plate electrode at the time of detecting the sound wave. As a result, the electrostatic capacitive microphone 100 has a characteristic of a narrow dynamic range because an attraction force is generated between the parallel plate electrode due to the applied electric field. Further, in the electrostatic capacitive microphone 100, it has been pointed out that the air resistance received by the movable electrode greatly affects the characteristics.

### Vibration Principle of Piezoelectric Microphone

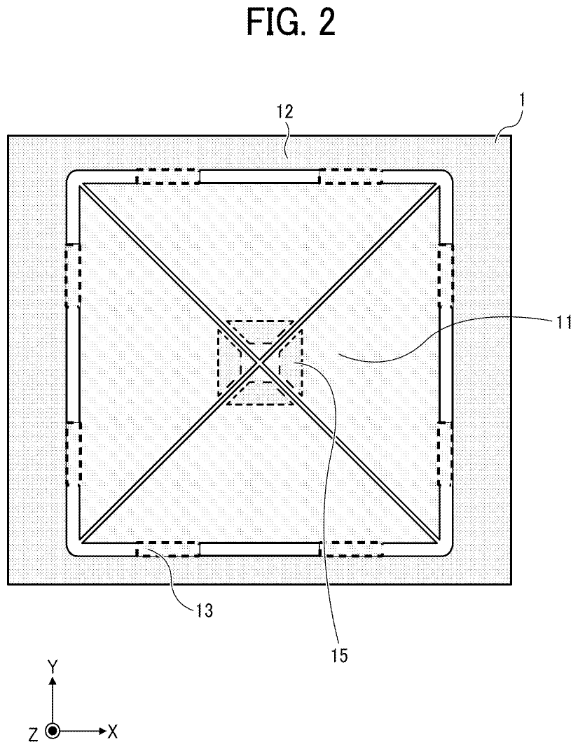

In order to address the issue described above, in the present embodiment, a configuration to which a piezoelectric microphone is applied will be described. FIG. 1 is a diagram of the vibration principle of a piezoelectric microphone. As illustrated in FIG. 1, a vibration detector 1 such as a piezoelectric microphone (piezoelectric MEMS microphone) detects a sound wave by converting displacement caused by the sound wave into an electrical signal (voltage) by the piezoelectric effect. Specifically, the vibration detector 1 is of a type in which the piezoelectric film 17 for generating charges by strain is directly formed on the vibration member 11 (vibration plate, or diaphragm). Herein, the directions of the respective portions (functions) configuring the vibration detector 1 will be described in the three dimensional coordinate axes. The X-direction is a lateral direction when the vibration detector 1 illustrated in FIG. 2, which will be described later, is viewed from above. Similarly, the Y-direction is a direction indicating a longitudinal direction when the vibration detector 1 illustrated in FIG. 2 is viewed from above. Similarly, the Z-direction is a direction indicating a depth direction when the vibration detector 1 illustrated in FIG. 2 is viewed from above (e.g., a direction from below to above when the vibration detector 1 is placed on a plane).

In this method, the vibration member 11 (diaphragm) vibrates in the plus and minus Z-directions as illustrated in FIG. 1 by the input of sound waves. As a result, stress is generated, so that the piezoelectric film 17 detects strain at a portion in which stress is generated. Thus, as a restriction on the movement in the plus and minus Z-directions, the piezoelectric microphone has a higher latitude than the electrostatic capacitive microphone. Further, since the vibration detector 1 can detect strain with a simple structure, the device fabrication process is simple and suitable for miniaturization. Further, since the vibration detector 1 does not use an input power supply, the passive circuit becomes simple and the vibration detector 1 can have a wide dynamic range.

However, it has been pointed out that the vibration detector 1 has relatively a low sensitivity, noise characteristics, or the S/N ratio as characteristics as compared with the electrostatic capacitive MEMS microphone. Thus, in order to increase the S/N ratio, the sensitivity and noise characteristics are increased. As a method for reducing noise caused by residual stress of a piezoelectric film, a piezoelectric microphone in which stress is reduced by a cantilever structure has also been proposed. On the other hand, there is room for sufficiently increasing the sensitivity in a low frequency region.

In the present embodiment, the low frequency refers to a frequency in the vicinity of a human audible band (e.g., 20 Hz to 20 kHz as a typical audible band), and a frequency of 100 Hz or less, for example. In typical MEMS microphones, a frequency band of 10 kHz to 20 kHz is often used. In the present embodiment, the microphone includes a sensor that can collect, condense. or detect sound. In other words, in the present embodiment, a microphone using, for example, a sensor that can collect, condense, or detect sound is used.

### Partial Plan View of Piezoelectric Microphone

A partial plan view of the piezoelectric microphone will be described. FIG. 2 is a partial plane view of the piezoelectric microphone according to the first embodiment. As illustrated in FIG. 2, in the vibration detector 1, one or more fixed end beam members 13 (i.e., rectangular portions surrounded by dotted lines) are disposed between each of the one or more vibration members 11 and the fixed member 12. In the example illustrated in FIG. 2, the one or more vibration members 11 are disposed on four substantially triangular shapes so as to substantially coincide with four regions divided by diagonal lines in the rectangle inside the fixed member 12 of the vibration detector 1. One or more fixed end beam members 13 (rectangular portions surrounded by dotted lines) are disposed on each of the one or more vibration members 11, and at least one of the sum of the lengths (total length) of the portions of the one or more fixed end beam members 13 connected to the fixed member 12 or the sum of the lengths (total length) of the portions of the one or more fixed end beam members 13 connected to the vibration member 11 is shorter than the length of the portion of the vibration member 11 (i.e., the length of the triangle base) facing the fixed member 12. In other words, each fixed end beam member is connected to the fixed member 12 within a range shorter than the length of the side closest to the fixed member among the sides of the vibration member 11 having a substantially triangular shape. For this reason, an effect of relieving the restraint of the vibration member 11 from the fixed member 12 can be brought. Herein, each direction of the three dimensional coordinate axes (X-axis, Y-axis, and Z-axis) of each portion (function) configuring the vibration detector 1 will be described. The X-direction is a lateral direction when the vibration detector 1 is viewed from above. The Y-direction is a longitudinal direction orthogonal to the X-direction (lateral direction) when the vibration detector 1 is viewed from above. The Z-direction is a direction indicating a depth direction orthogonal to the X-direction and the Y-direction when the vibration detector 1 is viewed overhead (e.g., a direction from the bottom to the top when the vibration detector 1 is placed on a plane). Herein, the three dimensional coordinate axes of the vibration detector illustrated in the similar positional relation indicate the same directions as those illustrated in FIG. 2, respectively. In the present embodiment, a weight member 15 formed of a support layer is added in a direction (a free end or a tip end) away from the center of gravity of one or more vibration members 11 from the fixed member 12 of one or more vibration members 11. Accordingly, the structure is such that the typical natural frequency represented by the following expression (1) is lowered and the sensitivity of vibration in the low frequency band is increased.

$$Fn = \frac{1}{2 π} \sqrt{( K / m )} , \qquad ( 1 )$$

where Fn is natural frequency [Hz], K is spring constant [N/m], m is mass [kg].

The length of one side of the vibration detector 1 illustrated in FIG. 2 is, for example, about 1 to 3 mm. However, the length is not limited thereto, and may be even shorter. Further, the shape of the vibration detector 1 is not limited to a rectangle (square), but may be another polygon, or a circle (round).

In some embodiments, a vibration detector includes: a vibration member to vibrate in a thickness direction; a fixed end beam member connected to the vibration member at one end of the fixed end beam member in a first direction; a fixed member connected to another end of the fixed end beam member in the first direction; and a strain detection member on at least one of the fixed end beam member or the vibration member and to detect strain of the vibration member. A length of the one end in a second direction perpendicular to the first direction and the thickness direction is shorter than a length of one side of the vibration member in the second direction, the one side of the vibration member is opposed to the fixed member in the first direction.

In some embodiments, the vibration detector includes: multiple vibration members including the vibration member; and multiple fixed end beam members including the fixed end beam member. A total length of the one end of the fixed end beam member of the multiple fixed end beam members is shorter than a length of the vibration member opposed to the fixed member.

In some embodiments, a vibration detector includes: a vibration member to vibrate in a thickness direction; a fixed end beam member connected to the vibration member at one end of the fixed end beam member in a first direction; a fixed member connected to another end of the fixed end beam member in the first direction; and a strain detection member on at least one of the fixed end beam member or the vibration member and to detect strain of the vibration member. A length of the another end in a second direction perpendicular to the first direction and the thickness direction is shorter than a length of one side of the vibration member in the second direction, the one side of the vibration member is opposed to the fixed member in the first direction.

### Plan View of Piezoelectric Microphone

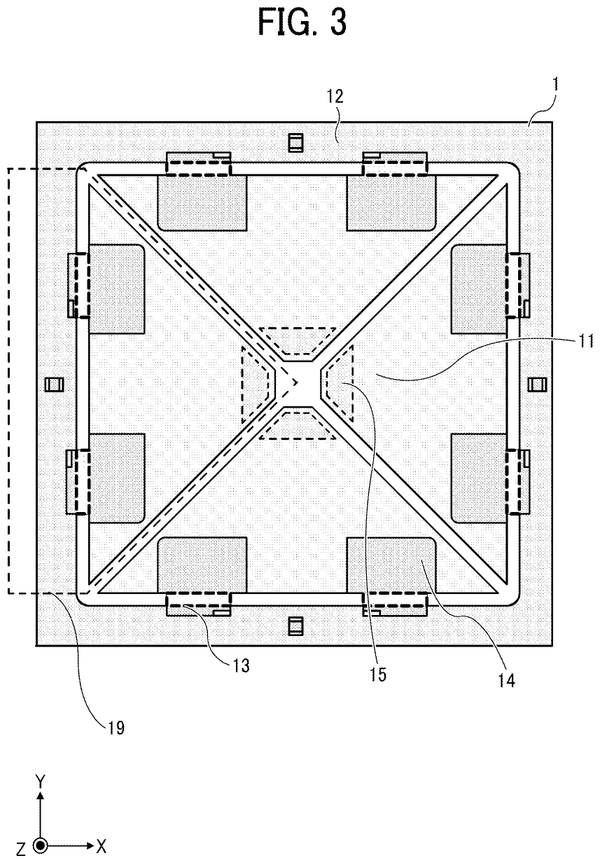

A plan view of the piezoelectric microphone will be described. FIG. 3 is a plan view of the piezoelectric microphone according to the first embodiment. As illustrated in FIG. 3, the vibration detector 1 including a piezoelectric microphone as an example includes one or more vibration members 11, a fixed member 12, the fixed end beam members 13 (a rectangular portion surrounded by a dotted line), and the strain detection members 14. The configuration of the vibration member 11 is the same as the configuration described in FIG. 2 in terms of the shape and number. In the example illustrated in FIG. 3, one or more fixed end beam members 13 are arranged at predetermined intervals so as to be symmetrical on each side facing the fixed member 12. As described above, in the first embodiment, one or more fixed end beam members are disposed at predetermined intervals to reduce rotation of the vibration member in the θ (theta) direction described later while maintaining strength in the X-axis direction and the Y-axis direction.

Among these, one or more vibration members 11 are connected to the fixed member 12 via one or more fixed end beam members 13. Herein, a “beam member” is typically a member that mainly supports the force of, for example, a building, and is one of the structural bodies. Thus, in the present embodiment, the fixed end beam member refers to a member for connecting the vibration member 11 and the fixed member 12. Accordingly, one or more fixed end beam members 13 are disposed between one or more vibration members 11 and the fixed member 12, and have a function of connecting the one or more vibration members 11 and the fixed member 12. As described above, when connecting each vibration member 11 to the fixed member 12 via the fixed end beam member 13, a support point at the time of connection is divided so that the supporting length is shorter than the length of a portion connected to the typical fixed member 12. In other words, the one or more fixed end beam members 13 are disposed so that at least one of the sum of the lengths (total length) of the portions of the one or more fixed end beam members 13 connected to the fixed member 12 or the sum of the lengths (total length) of the portions of the one or more fixed end beam members 13 connected to the vibration member 11 is shorter than the length of the portion of the vibration member 11 facing the fixed member 12. As a result, the natural frequency of the vibration member can be lowered, and further the sensitivity in the low frequency region can be increased. Although the vibration member 11 illustrated in FIG. 3 has a substantially triangular shape, the shape of the vibration member 11 is not limited thereto. For example, the shape of the vibration member 11 may be a circular shape or another polygonal shape.

As described above, for the purpose of dispersing the influence in the θ-direction, which will be described later, one or more fixed end beam members are disposed while maintaining the strength in the X-axis and Y-axis directions.

Further, in the example illustrated in FIG. 2, each of the inner four corners of the fixed member 12 has a shape to which round chamfering (e.g., fillet) is applied. This is because, if the inner corner of the fixed member 12 has the right angle, the fixed member 12 is apt to break due to a crack caused by a stress concentrated in the portion, and the fixed member 12 is formed into a shape with round chamfering to disperse the stress concentration. The round chamfering may be applied to other embodiments in other drawings with the same aim

Vibration Member, Fixed End Beam Member, and Boundary between Vibration Member and Fixed End Beam Member

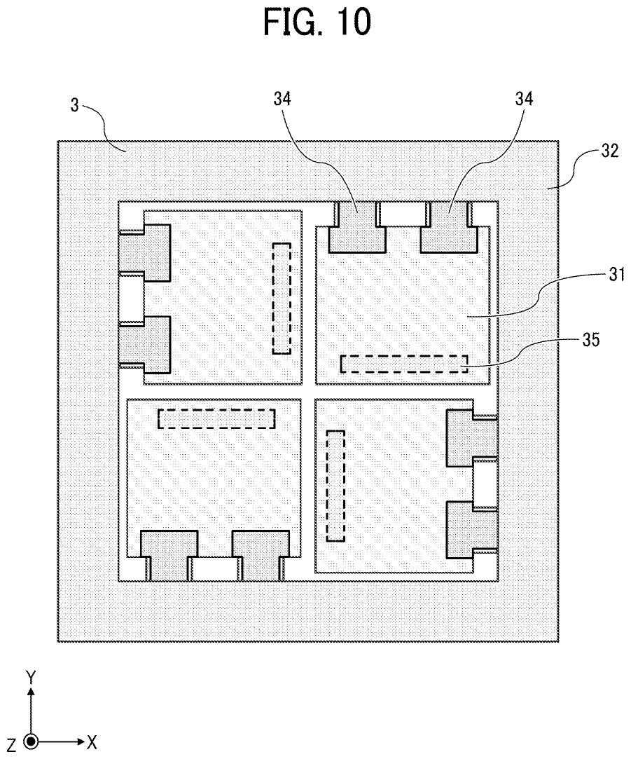

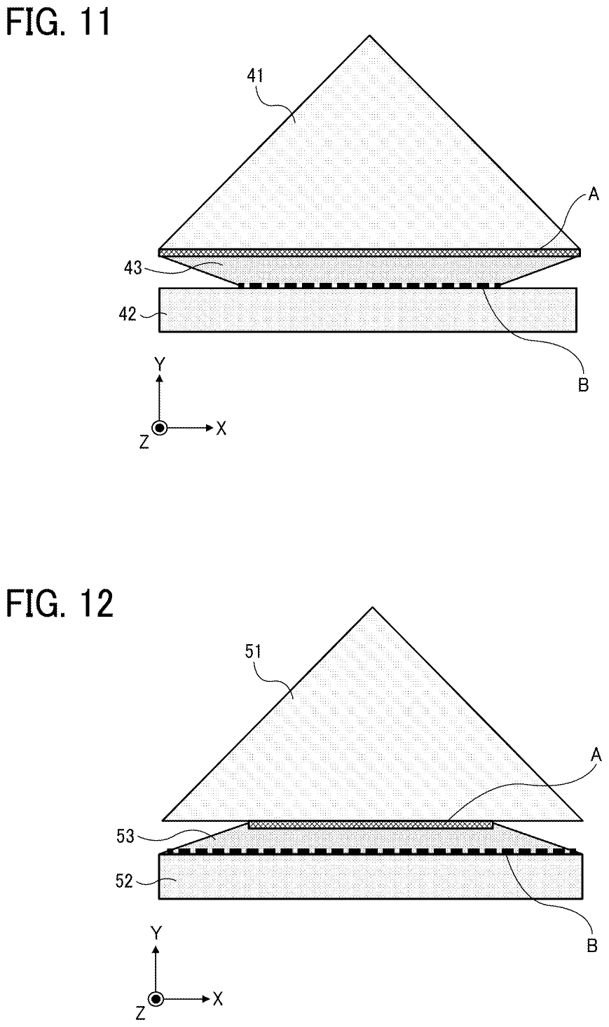

The definitions of the vibration member, the fixed end beam member, and these boundaries will be described. In the XY-plane in the XYZ-coordinate system illustrated in FIG. 2, members up to a position in which the width initially becomes maximum (e.g., the example in FIG. 11 described later), a position in which the width initially becomes minimum (e.g., the example in FIG. 12 described later), or a position in which the width initially becomes discontinuous (e.g., the examples in FIGS. 2 to 10) in a direction away from the connection position with the fixed member 12 are referred to as fixed end beam members. A member connected to the fixed end beam member is a vibration member. At this time, a boundary (a boundary A described later) between the fixed end beam member and the vibration member is a straight line in which a boundary (a boundary B described later) between the fixed member and the fixed end beam member is parallel to each other along the X-direction. When the boundary (the boundary B described later) between the fixed member and the fixed end beam member has a curvature, the boundary may also have substantially the same curvature.

Herein, the “portion” such as the portion connected to the fixed member 12 of one or more fixed end beam members 13 and the portion connected to the vibration member 11 of one or more fixed end beam members 13 is defined as follows in the present embodiment. For example, as illustrated in FIG. 3, when the vibration member 11 has a substantially triangular shape, the “portion” can be defined as including a “side”. Further, when the outer periphery (outer edge) of the vibration member 11 is formed in a circle, or a sector having a constant curvature, the “portion” can be defined as including an “arc” forming the outer periphery (outer edge).

In the direction (X-direction or Y-direction) perpendicular to the vibration direction in which the one or more vibration members 11 vibrate in the plus and minus Z-directions, the tip of the one or more vibration members 11 in the direction away from the fixed member 12 has a chamfering shape. The chamfering shape in this case may be, for example, round chamfering (rounded corners), a chamfer (corners having a right angle are shaved off at an angle of 45 degrees), or bevel. Further, the tip end of one or more vibration members 11 formed of a cantilever structure is formed into the chamfering shape as described above. As a result, contact with one vibration member 11 and another vibration member 11, which are adjacent to each other, can be avoided when the vibration member is displaced, and damage of the vibration member 11 can be prevented.

In some embodiments, in the vibration detector, a tip of the vibration member in a direction away from the fixed member is chamfered.

In some embodiments, in the vibration detector, the vibration member has a cantilever structure having: one end connected to the fixed end beam member; and another end as a free end.

The strain detection member 14 has a function of detecting a sound wave by converting a strain accompanying the vibration of one or more vibration members 11 into an electrical signal (voltage) by the piezoelectric effect of the distortion detection member 14.

The strain detection member 14 is disposed in the vicinity of one or more fixed end beam members 13 or one or more fixed end beam members 13 in the one or more vibration member 11, or in the vicinity of one or more fixed end beam member 13 and one or more fixed end beam members 13 in one or more vibration member. The strain detection member 14 is made of a piezoelectric material such as titanium-lead zirconate Pb (Zr, Ti) O₃ (PZT) or aluminum nitride (AlN).

In the present embodiment, the one or more vibration members 11 and the one or more fixed end beam members 13 configuring the vibration detector 1 are disposed in a size as illustrated in FIG. 3, for example. At this time, in order to efficiently detect the vibration caused by sound as strain, the vibration member 11 may be large, but the initial capacity also becomes large, so that a trade-off occurs in a load (power consumption) or noise on the circuitry increase when the strain is detected. Thus, the sensitivity is maintained without increasing the detection area, and the sizes of the vibration member 11 and the strain detection member 14 are balanced.

To cope with such a trade-off, in the present embodiment, the fixed end beam member 13 connecting a single vibration member 11 and the fixed member 12 is disposed at two places (or multiple places), and the strain detection member 14 is disposed so as to straddle the fixed end beam member 13. As a result, the strain detection member 14 can reduce the area of the strain detection member 14 itself while efficiently detecting the strain. Furthermore, power consumption can be reduced by decreasing the capacitance value in the detection circuitry of the strain detection member 14.

### Side View of Piezoelectric Microphone

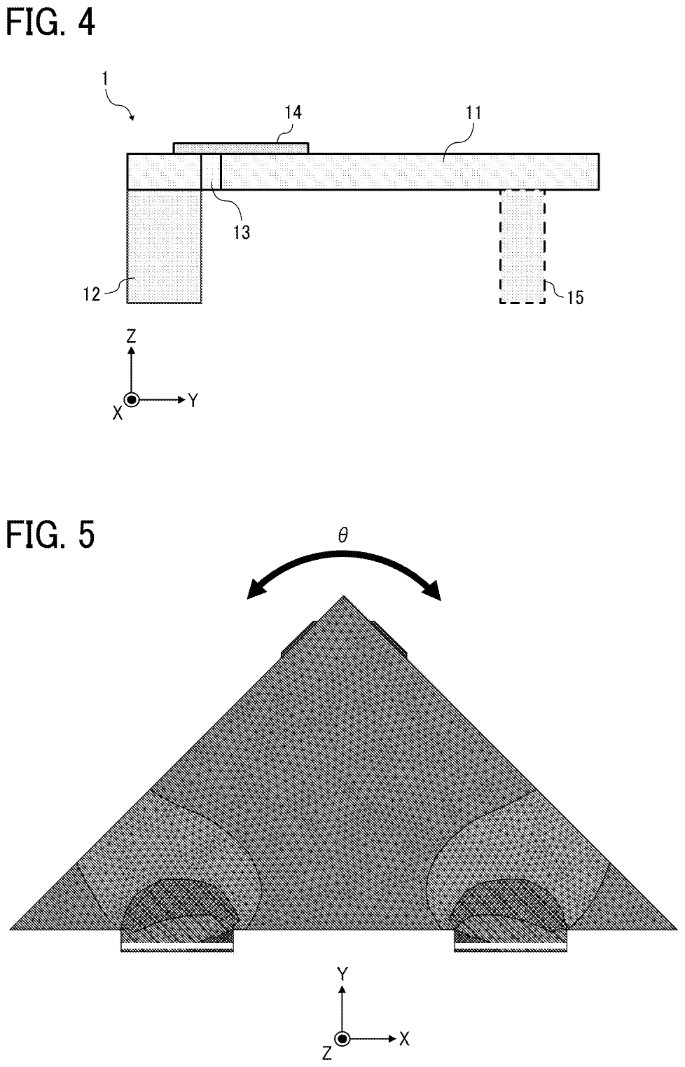

A side view of the piezoelectric microphone will be described. FIG. 4 is a view of a side surface of the piezoelectric microphone according to the first embodiment. FIG. 4 schematically illustrates a side surface of the piezoelectric microphone illustrated in FIG. 3 with respect to the side surface observation region 19 (a pentagonal portion surrounded by a dotted line). Specifically, FIG. 4 is an example of a schematic diagram that can be viewed when the side surface observation region 19 is FIG. 3 is rotated by 90° around the Z-axis. As with the case illustrated in FIG. 1, the vibration detector 1 includes multiple fixed end beam members 13. The strain detection member 14 is disposed on multiple fixed end beam members 13 and one or more vibration members 11. The strain detection member 14 disposed on the multiple fixed end beam members 13 is continuous with the strain detection member 14 disposed on the one or more vibration member 11. Specifically, in the vibration detector 1, among the fixed member 12, one or more fixed end beam members 13, one or more vibration members 11, and the strain detection member 14, one set of the fixed member 12, the fixed end beam member 13, the vibration member 11, and the strain detection member 14 are bonded to each other to form a single body. More specifically, in the vibration detector 1, the fixed end beam member 13 and the vibration member 11 are molded (bonded) to each other to form a single body in the Y-direction to a part of the fixed member 12 by using a well-known semiconductor bonding technique. The material to be molded to each other to form a single body includes, for example, silicon (silicon dioxide: SiO₂ (O₂ denotes an oxygen molecule). Further, the strain detection member 14 is bonded to each other to for a single body to at least one of the vibration member 11 or the fixed end beam member 13 by a film forming process of a semiconductor process.

In some embodiments, in the vibration detector, the strain detection member covers both of the fixed end beam member and the vibration member.

In some embodiments, in the vibration detector, the fixed member, the fixed end beam member, the vibration member, and the strain detection member are bonded to each other to form a single body.

The weight member 15 is connected to one or more vibration members 11, and is disposed in a direction away from the fixed member 12 from the center of gravity of the one or more vibration members 11, for example, near the tip of the vibration member 11. When the weight member 15 is disposed near the tip of the vibration member 11, the moment of inertia of the vibration system becomes larger than the inertia of the vibration system before the weight member 15 is disposed. Further, the natural frequency becomes lower than that before the weight member 15 is disposed.

Further, the displacement of the vibration member 11 due to the sound wave is larger than that before the weight member 15 is disposed, so that the detection sensitivity is increased. Further, as illustrated in FIG. 3, the weight member 15 is disposed at a position symmetrical to one or more fixed end beam members 13. By disposing the weight member 15 as described above, the fixed end beam member 13 of the cantilever vibration member as illustrated in FIG. 2 is divided into multiple portions, and a supporting layer (weight) is added near the tip of the cantilever vibration member, whereby the natural frequency of the vibration member can be designed to be low and the sound detection sensitivity in the low frequency region can be increased.

In some embodiments, in the vibration detector, the vibration member further includes: a weight member at a position: symmetrical with respect to the fixed end beam member in the second direction; and closer to a tip of the vibration member than the one end of the fixed end beam member in the first direction.

Further, the distance between the weight member 15 and the fixed member 12 in the Y-direction can be appropriately changed in the design stage of the vibration detector 1. Further, the length (thickness or width) of the weight member 15 in the Y-direction can be appropriately changed at the stage of designing the vibration detector 1. As a result, the natural frequency in the design stage of the vibration detector 1 can be adjusted. In other words, the position of the weight member 15 can be adjusted in accordance with the band of the sound to be measured. It is preferable that the weight member 15 is disposed at a position apart from a connection position between the vibration member 11 and the fixed end beam member 13, and is disposed at a position symmetrical with respect to the arrangement of the fixed end beam member 13. As a result, the natural frequency of the vibration member can be designed to be low while reducing vibration generated in the θ-direction, which will be described later, and the sound detection sensitivity in the low frequency region can be increased. Further, in the vibration system including one or more vibration members 11, a fixed end beam member 13, and a weight member 15, the natural frequency of the vibration system and the sensitivity of the microphone can be adjusted by the number of divisions and the size of the fixed end beam member 13 and the mounting position and the size of the weight member 15.

In the present embodiment, the above-described functional members have different functions, but the respective functions (portions) are molded (bonded) to each other to form a single body using a semiconductor bonding technique.

### Vibration Member and Strain Distribution on Fixed End Beam Member

The strain distribution in the shape of the vibration member and the fixed end beam member will be described. FIG. 5 is a diagram of a strain distribution in the shape of the vibration member and the fixed end beam according to the first embodiment. The simulation distribution diagram illustrated in FIG. 5 is the strain distribution simulated by finite element method (FEM). The result indicates that a portion closer to the fixed end beam member 13 (thicker portion) has a larger strain, and another portion closer to the oblique side of the triangle has a smaller strain. In other words, the distribution is not symmetrical with respect to the center of the fixed end beam member, but the distribution is such that the strain spreads outward. Based on the present simulation result, in the present embodiment, the strain detection member 14 is formed asymmetrically with respect to the center of the fixed end beam member 13. Specifically, the strain detection member 14 is formed to be deviated from the center of the fixed end beam member 13 toward the outside of the vibration member 11. Thus, the strain detection member 14 can detect the strain with high sensitivity.

In some embodiments, in the vibration detector, the strain detection member is asymmetrical with respect to a center of the fixed end beam member in the second direction.

A portion of the strain detection member 14 is disposed on the fixed end beam member 13 having a large strain due to sound waves. As a result, the strain detection member 14 can efficiently detect the strain.

In FIG. 5, the θ-direction is further defined as the direction in which the vibration member vibrates. The θ-direction is the direction in which the vicinity of the tip of the vibration member 11 illustrated in FIG. 3 (the apex of the vibration member on the side at which the weight member is disposed) vibrates when the vibration member is formed into a substantially triangular shape, and is indicated by a double arrow in the XY-plane in FIG. 5.

### Detection Electrode Wiring Configuration

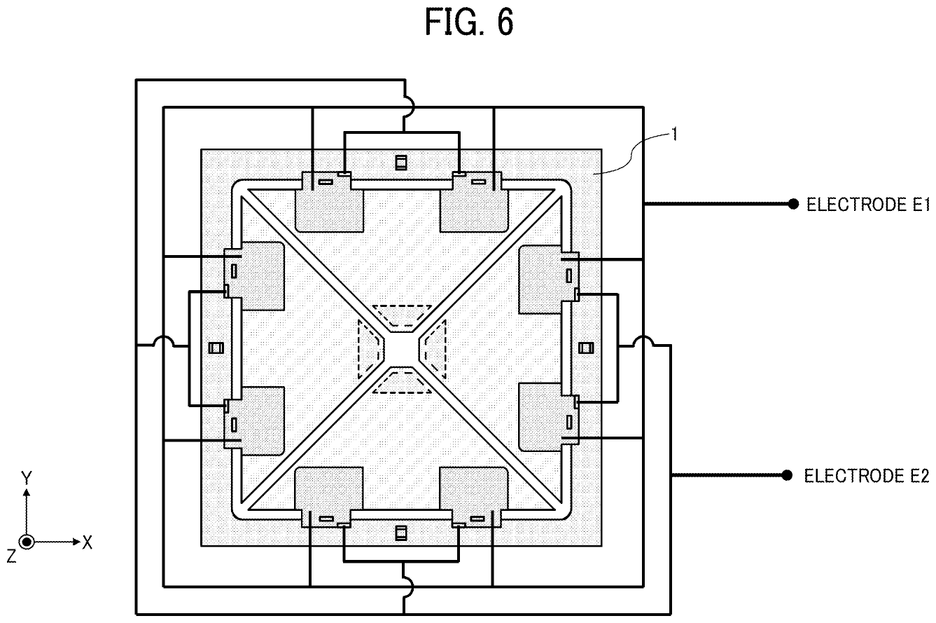

The configuration of the detection electrode wiring will be described. FIG. 6 is a diagram of a detection electrode wiring configuration according to the first embodiment. In FIG. 6, an example of wiring configuration is schematically illustrated when connecting to the electrode E1 and the electrode E2. In the present example, the strain detection member 14 is configured by a piezoelectric element, and the piezoelectric element cannot detect electrical charge unless the piezoelectric element is sandwiched between the electrode E1 and the electrode E2 vertically. As a result, in FIG. 6, the electrodes are disposed on the electrode E1 and the electrode E2, respectively, and wires are connected to the electrodes.

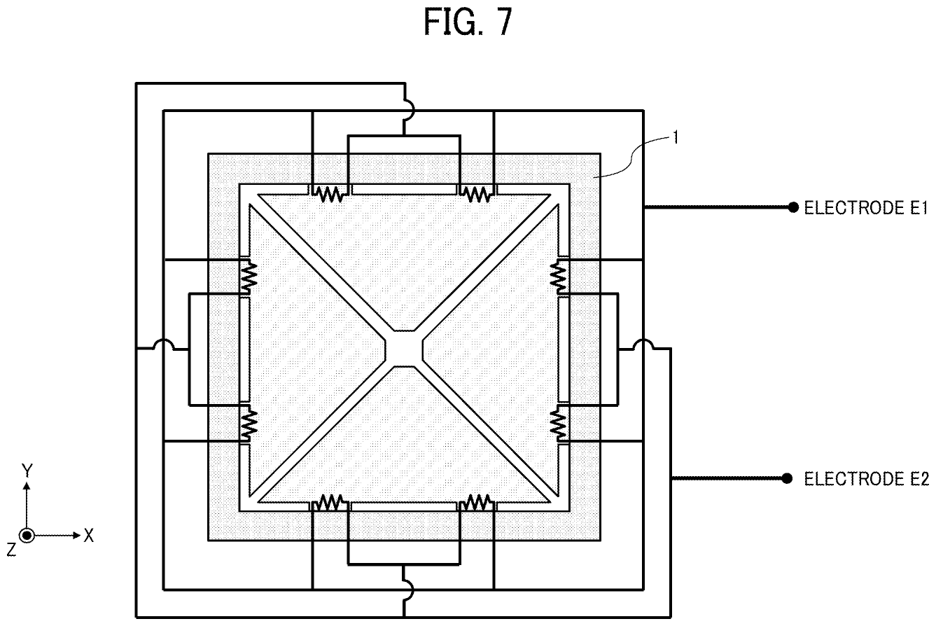

FIG. 7 is a schematic diagram of the piezoresistance arrangement according to the first embodiment. The piezoresistance illustrated in FIG. 7 has a structure in which a resistor is embedded in silicon, for example, and by arranging and wiring the piezoresistance, a microphone can be configured instead of the piezoelectric microphone. As a result, the strain detection member according to the present embodiment is applied to the piezoelectric microphone and piezoresistive microphone described above based on the detection principle thereof. Thus, the strain detection member 14 converts the vibration of one or more vibration members into an electrical signal by the piezoelectric effect or the piezoresistance.

In some embodiments, in the vibration detector, the strain detection member includes a piezoelectric film to convert a vibration of the vibration member into an electronic signal.

### Main Advantages of First Embodiment

As described above, according to the present embodiment, the one or more fixed end beam members 13 in the vibration detector 1 are disposed such that the total length of the portions of the one or more fixed end beam members 13 connected to the fixed member 12 is different from the length of the portions of the one or more vibration members 11 connected to the one or more fixed end beam members 13 and facing the fixed member 12. As a result, the sensitivity in the low frequency region can be further increased.

### Second Embodiment

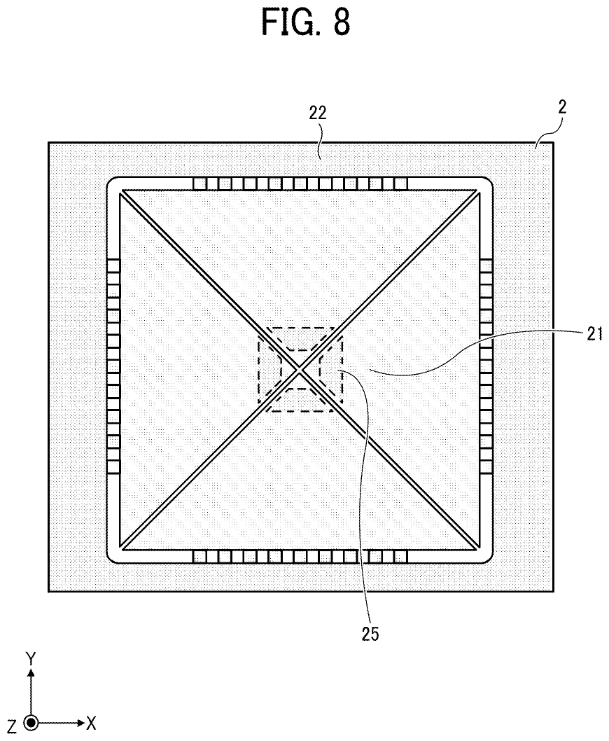

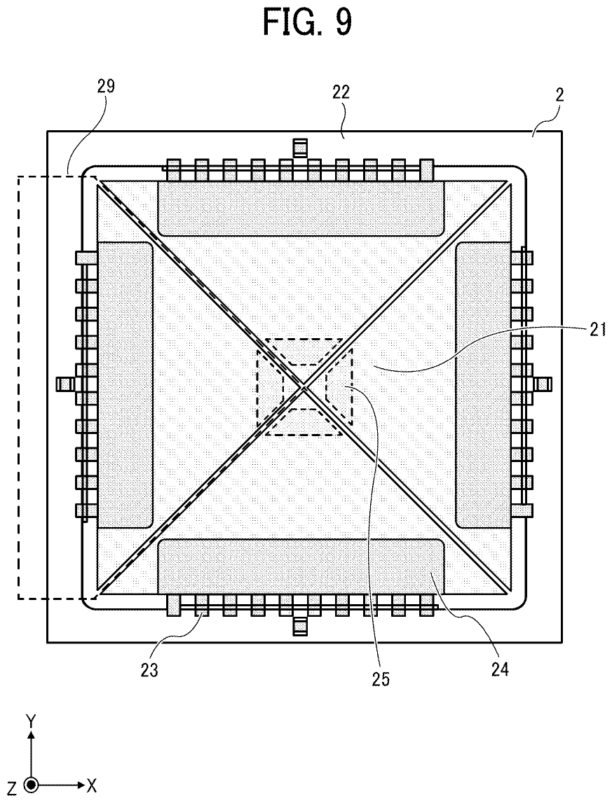

A second embodiment will be described with reference to FIGS. 8 and 9. In the first embodiment, the structure in which two fixed end beam members 13 are disposed for one vibration member 11 has been described.

In contrast to such a structure, the second embodiment proposes a case where the number of fixed end beam members for connecting a certain vibration member and a fixed member among one or more vibration members is larger than the number of fixed end beam members illustrated in the first embodiment. In the second embodiment, in order to further reduce the rotation of the vibration member in the θ-direction, the fixed end beam member is divided into pieces having the number smaller than the number of the piece in the first embodiment and disposing the fixed end beam member at a predetermined interval smaller than the interval in the first embodiment while maintaining the strength in the X-axis and Y-axis directions in the same manner as in the first embodiment.

### Partial Plan View of Piezoelectric Microphone

A partial plan view of the piezoelectric microphone will be described. FIG. 8 is a partial plan view of the piezoelectric microphone according to the second embodiment as an example. FIG. 8 is a diagram of a case where the number of fixed end beam member for connecting one vibration member and the fixed member is further increased (nine fixed end beam members for each vibration member in the example illustrated in FIG. 8) unlike the case described in FIG. 3. In the example illustrated in FIG. 8 as well as in FIG. 2, each of the one or more vibration members 21 is formed in four substantially triangular shapes so as to substantially coincide with four regions divided by diagonal lines in the rectangle inside the fixed member 22 in the vibration detector 2.

### Plan View of Piezoelectric Microphone

A plan view of the piezoelectric microphone will be described. FIG. 9 is a plan view of the piezoelectric microphone according to the second embodiment. The vibration member 21 has a configuration having the same shape and number described with reference to FIG. 8. FIG. 9 illustrates, as an example, a state in which nine fixed end beam members 23 are respectively connected to the fixed member 22 for one vibration member 21. In the example illustrated in FIG. 9, multiple fixed end beam members 23 that are further subdivided into pieces smaller than the pieces in the first embodiment are arranged at predetermined intervals so as to be symmetrical on each side facing the fixed member 22. In the case illustrated in FIG. 9, similarly to the case illustrated in FIG. 3, the reason for installing the fixed end beam members having the number larger than the number of the fixed end beam members in the first embodiment is to further reduce the rotation of the vibration member in the θ-direction while maintaining the strength in the X-axis and the Y-axis directions. In such a way, by changing the width, length, and number of divisions of the fixed end beam member 13, the natural frequency of the vibration system and the sensitivity of the microphone can be further adjusted. A interval (gap) between the fixed end beam members 23 each is less than twice of a width of the fixed end beam member 23. This is because, when the interval (gap) between the fixed end beam members is large, the strain of the strain detection member is alternately generated with compression and tension and offset, so that the detection voltage cannot be obtained efficiently. The number (division number) and arrangement position of the fixed end beam members 23 illustrated in FIG. 9 are not particularly limited as long as the influence in the θ-direction described above can be dispersed. As a result, such a method efficiently generates strain of the strain detection member 24, and the detection sensitivity can be increased.

### Main Advantages of Second Embodiment

As described above, according to the present embodiment, the multiple fixed end beam members 23 are arranged symmetrically on the side facing the fixed member 22. As a result, in addition to the effect obtained by the first embodiment, the influence on the θ-direction can further be dispersed. The number of the fixed end beam members and the interval between the fixed end beams are not limited to those disclosed in the present embodiment as long as the above-described effect can be obtained.

### Modification of Vibration Member and Fixed End Beam Member

### Shape Modification of Vibration Member

A shape modification of the vibration member will be described. FIG. 10 is a diagram of a shape modification of the vibration member. As illustrated in FIG. 10, four vibration members 31 each having a rectangular shape are arranged inside the fixed member 32. Two strain detection member 34 are arranged at positions connected to the fixed member 32 of the vibration member 31. Further, one weight member 35 is disposed in each of the vibration members 31 in the vicinity of a side facing the two strain detection members 34 connected to the fixed member 32.

One or more weight members 35 may be disposed for each vibration member 31. The vibration member 31 having such a shape has a layout in which the vibration member having a triangular shape as illustrated in FIGS. 3 and 9 detects strain omnidirectional in terms of directivity. On the other hand, the vibration member 31 illustrated in FIG. 10 has a configuration suitable for increasing the detection sensitivity at a specific angle. For example, the vibration members 31 located at the upper left and lower right and the respective strain detectors 34 connected thereto have a characteristic sensitivity in the X-direction. Similarly, the vibration members 31 located at the upper right and lower left and the respective strain detectors 34 connected thereto have a characteristic sensitivity in the Y-direction.

### First Modification of Fixed End Beam Member

A modification of the shape of the fixed end beam member will be described. FIG. 11 is a diagram of an example of a first modification of the fixed end beam member. In FIG. 11, when the vibration member 41 is connected to the fixed member 42 via the fixed end beam member 43, at least one of the sum of the lengths of the boundary B of the fixed end beam member 43 connected to the fixed member 42 or the sum of the lengths of the boundary A of the fixed end beam member 43 connected to the vibration member 41 is shorter than the length of the portion of the vibration member 41 opposed the fixed member 42. In particular, FIG. 11 illustrates a state in which the total length of the boundary B is shorter than the length of the portion of the vibration member 41 opposed to the fixed member 42.

### Second Modification of Fixed End Beam Member

Another shape modification of the fixed end beam member will be described. FIG. 12 is a diagram illustrating an example of a first modification of the fixed end beam member. In FIG. 12, when the vibration member 51 is connected to the fixed member 52 via the fixed end beam member 53, at least one of the sum of the lengths of the boundary A of the fixed end beam member 53 connected to the fixed member 52 or the sum of the lengths of the boundary B of the fixed end beam member 53 connected to the vibration member 51 is shorter than the length of the portion of the vibration member 41 opposed to the fixed member 42. FIG. 12 particularly illustrates a state in which the total length of the boundary A is shorter than the length of a portion of the vibration member 51 opposed to the fixed member 52.

FIG. 12 illustrates the case where the length of the boundary B is substantially the same as the length of the longer side of the fixed member 52, but the present embodiment is not limited thereto, and the length of the boundary B may be shorter than the length of the longer side of the fixed member 52.

### Other Modification of Fixed End Beam Member

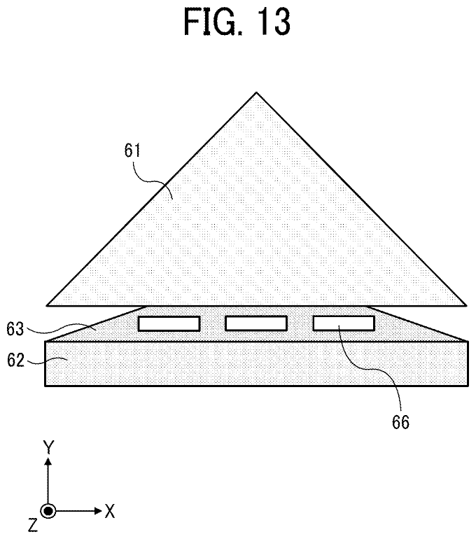

Another shape modification of the fixed end beam member will be described below. FIG. 13 is a diagram of an example of another modification of the fixed end beam member. FIG. 13 illustrates an example of a vibration detector in which a vibration member 61 and a fixed member 62 are connected via the fixed end beam member 63 in which an opening having a predetermined size is formed. In FIG. 13, one or more openings 66 are formed in each of the one or more fixed end beam members 63. As described above, in the present embodiment, a configuration in which one or more openings 66 are formed inside the fixed end beam member 53 may be applied to the fixed end beam member.

In some embodiments, in the vibration detector, the fixed end beam member has one or more openings.

Various configurations and various functions illustrated in FIGS. 1 to 10 can be similarly applied to the vibration detector having the fixed end beam member 63 as illustrated in FIG. 13.

### Shape Modification of Vibration Member and Arrangement of Strain Detection Member

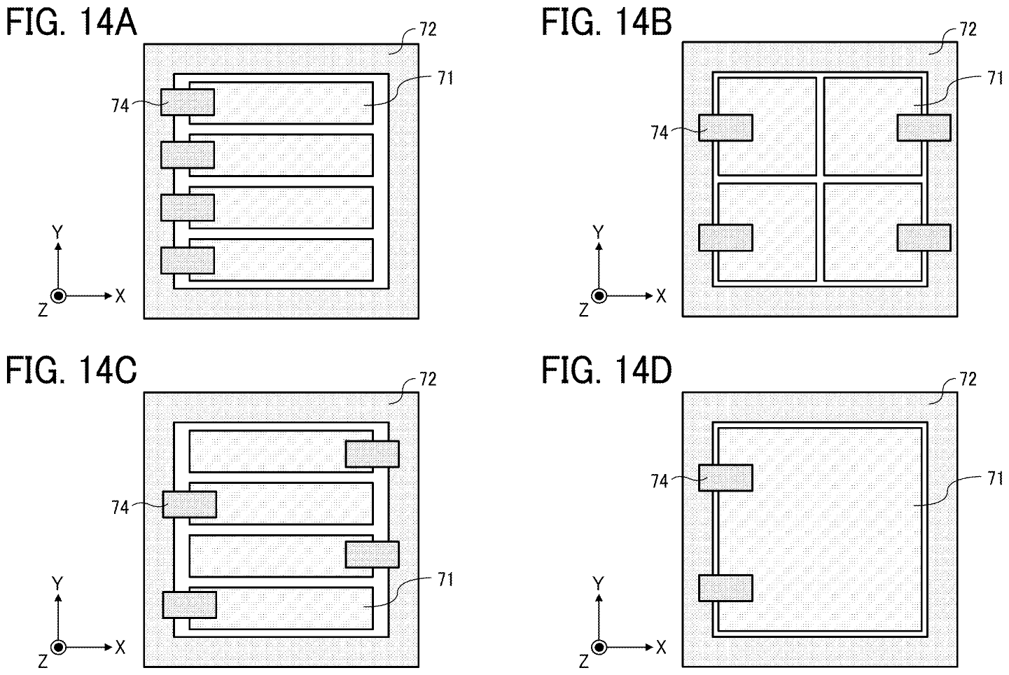

An example of a modification of the shape of the vibration member and the arrangement of the strain detection member will be described. FIGS. 14A to 14D are diagrams of modifications of the shape of the vibration member and the arrangement of the strain detection member. FIG. 14A illustrates an example in which four strain detection members are arranged at the same coordinate in the X-direction. FIG. 14B is a diagram of an example in which two strain detection members are arranged at two coordinates in the X-direction (i.e., four strain detection members in total). FIG. 14C is a diagram of an example in which the coordinates of the strain detection members are staggered in the Y-direction with respect to the arrangement example of FIG. 14A (i.e., four strain detection members in total). Similarly, FIG. 14D is a diagram of an example in which two strain detection members are arranged in one vibration member. As described in FIG. 10, the shapes of the respective vibration members and the arrangement of the strain detection member corresponding to the respective shapes may be appropriately selected and arranged in a case where the detection sensitivity at a specific angle is increased, for example.

The vibration detector 1 described in the first and second embodiments may be incorporated into a wearable device such as a wristwatch device, a glasses device, a head mounted display (HMD), or a body mounted device, which can be directly or indirectly mounted on the human body of a user. According to such a use from, for example, a wearable device incorporating the vibration detector 1 has a function of converting strain information relating to various data such as heartbeat, heart rate (pulse rate), blood pressure, breath sound, and respiration rate detected by the vibration detector 1 into vital data. The wearable device may store the vital data in a predetermined storage unit installed in the wearable device body or in an external storage server via a predetermined communication network. The wearable device may further send the converted vital data to another communication device at any timing. Measurement data such as vital data attached to any user and measured with other communication devices can be shared.

The present embodiment can be applied to the vibration detector and an electroacoustic transducer (e.g., a sound wave detector including an ultrasonic wave, a piezoelectric microphone, piezoresistive microphone, or a speaker) including the vibration detector.

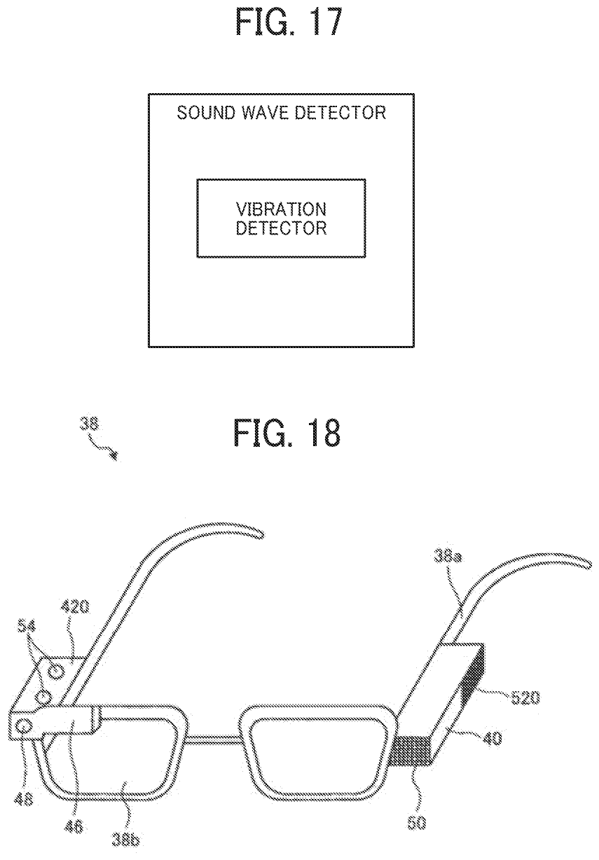

In FIG. 17, the sound wave detector to which the vibration detector according to at least one embodiment is applied further increases sensitivity in a low frequency range.

FIG. 18 is a schematic diagram for explaining the external configuration of the wearable device 38 (eyeglass wearable device) as an example.

As an example, the wearable device 38 (eyeglass wearable device) includes a first unit 40 and a second unit 420.

As an example, the first unit 40 is installed in a part of the eyeglass frame 38a, and includes a controller for controlling the entire wearable device 38, a battery, a microphone, or a speaker.

The second unit 420 is also installed in a part of the eyeglass frame 38a, and includes a display unit, a camera, a switch, or various sensors.

The user wears the wearable device 38 on the head as if wearing glasses.

As a result, the image displayed on the display unit provides augmented reality in front of the eyes of the user and provides various information.

Further, although the wearable device 38 (the eyeglass wearable device) is illustrated as an example of the wearable terminal in the above-described embodiment, the present embodiment can be applied to other types of wearable terminals.

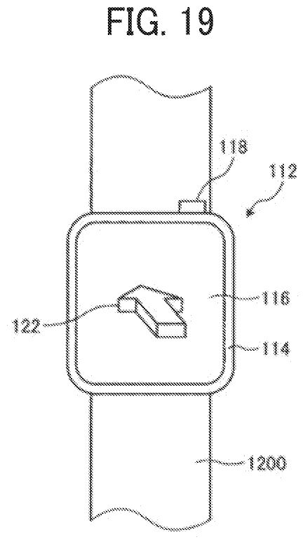

In FIG. 19, a wearable device 112 of a wristwatch wearable device is illustrated as another example of the wearable terminal.

The wearable device 112 includes a display member 116 disposed on the surface of the main body 114, a camera 118 disposed on the side surface of the main body 114, and a band 1200 for supporting the main body 114 and fixing the main body to the wrist of the user.

The main body 114 includes a microphone, a speaker, and a switches in the case of the wearable device 38 (eyeglass wearable device).

In addition, connection jacks on which a earphones is mounted may be formed instead of the speaker.

A configuration similar to that of the controller 44 illustrated in FIG. 19 is stored in the main body 114, and various units similar to those illustrated in FIG. 6 are configured on the CPU 56 and function similarly.

In some embodiments, a sound wave detector includes the vibration detector.

In some embodiments, a microphone includes the vibration detector.

In some embodiments, a wearable device includes the vibration detector.

### Supplement to Embodiment

Although the vibration detector and the wearable device according to the embodiments of the present invention have been described above, the present invention is not limited to the above-described embodiments, and can be modified within a range that can be conceived by a person skilled in the art, such as addition, change, or deletion of other embodiments, and any of the embodiments is included in the scope of the present invention as long as the functions and effects of the present invention are achieved.

Aspects of the present invention is as follows, for example.

In a first aspect, a vibration detector includes: one or more vibration members; one or more fixed end beam members connecting to the vibration member at one end of the fixed end beam member; one or more fixed members connected to another end of the one or more of the fixed end beam members; and a strain detection member disposed on at least one of the fixed end beam member or the fixed member and configured to detect strain generated in the vibration member. At least one of the sum of lengths of the one or more fixed end beam members connected to the fixed member or the sum of lengths of the one or more fixed end beam members connected to the vibration member is smaller than the length of a part of the vibration member opposed to the fixed member.

According to the first aspect, sensitivity in a low frequency region can be further increased.

In a second aspect, in the vibration detector according to the first aspect, the strain detection member disposed on the fixed member is continuous to the strain detection member disposed on the vibration member.

According to the second aspect, as with the first aspect, sensitivity in a low frequency region is further increased, and the vibration detector considering the balance of the size of the vibration member and the size of strain detection member can be designed.

In a third aspect, in the vibration detector according to the first aspect or the second aspect, the strain detection member converts vibration by the one or more vibration detection members into an electrical signal by piezoelectric effect or piezoresistance.

According to the third aspect, the vibration detector as an alternative to the piezoelectric vibration detector can be provided.

In a fourth aspect, in the vibration detector according to any one of the first aspect to the third aspect, the vibration detection member is arranged to be asymmetric with respect to the central of the strain detection member.

According to the fourth aspect, the strain detection member can detect the strain with a high sensitivity.

In a fifth aspect, in the vibration detector according to any one of the first aspect to the fourth aspect, a tip of the one or more vibration member has a chamfering shape in a direction away from the fixed member.

According to the fifth aspect, one vibration member can avoid touching another vibration member adjacent to the one vibration member when the vibration member is displaced, and damage of the vibration members can be prevented.

In a sixth aspect, in the vibration detector according to any one of the first aspect to the fifth aspect, the fixed member, the fixed end beam member, the vibration member, and the strain detection member are bonded to each other to form a single body.

According to the sixth aspect, a typical semiconductor bonding technique to the design process of the vibration detector can be applied.

In a seventh aspect, in the vibration detector according to any one of the first aspect to the sixth aspect, the vibration member further includes a weight member in a direction away from the fixed member and the center of the gravity of the vibration member and at a position symmetric with respect to the one or more fixed end beam members.

According to the seventh aspect, in the design stage of the vibration detector, the natural frequency of the vibration member is designed to be low so that the sound detection sensitivity in the low frequency region can be increased.

In an eighth aspect, in the vibration detector 1 according to any one of the first aspect to the seventh aspect, the fixed member has one or more openings.

According to the eighth aspect, as with the first aspect, sensitivity in a low frequency region can be further increased.

In a ninth aspect, the sound wave detector includes the vibration detector according to any one of the first aspect to eighth aspect.

According to the ninth aspect, as with the first aspect, in the sound wave detector, the sensitivity in the low frequency range can be further increased.

In a tenth aspect, a microphone includes the vibration detector 1 according to any one of the first aspect to the eighth aspect.

According to the ninth tenth, as with the first aspect, the sensitivity in the low frequency region in the microphone can be further increased.

In an eleventh aspect, a wearable device includes the vibration detector according to any one of the first to the eighth aspect.

According to the eleventh aspect, as in the first aspect, in the sound wave detector, the sensitivity in the low frequency range can be further increased. Further, measurement data such as vital data, which is attached to any user and measured, with other communication devices can be shared.

In a twelfth aspect, a vibration detector includes: a vibration member to vibrate in a thickness direction; a fixed end beam member connected to the vibration member at one end of the fixed end beam member in a first direction; a fixed member connected to another end of the fixed end beam member in the first direction; and a strain detection member on at least one of the fixed end beam member or the vibration member and to detect strain of the vibration member. A length of the one end in a second direction perpendicular to the first direction and the thickness direction is shorter than a length of one side of the vibration member in the second direction, the one side of the vibration member is opposed to the fixed member in the first direction.

In a thirteenth aspect, the vibration detector according to the twelfth aspect, includes: multiple vibration members including the vibration member; and multiple fixed end beam members including the fixed end beam member. A total length of the one end of the fixed end beam member of the multiple fixed end beam members is shorter than a length of the vibration member opposed to the fixed member.

In a fourteenth aspect, in the vibration detector according to the twelfth aspect or the thirteenth aspect, the strain detection member covers both of the fixed end beam member and the vibration member.

In a fifteenth aspect, in the vibration detector according to any one of the twelfth aspect to the fourteenth aspect, the strain detection member includes a piezoelectric film to convert a vibration of the vibration member into an electronic signal.

In a sixteenth aspect, in the vibration detector according to any one of the twelfth aspect to the fifteenth aspect, the strain detection member is asymmetrical with respect to a center of the fixed end beam member in the second direction.

In a seventeenth aspect, in the vibration detector according to any one of the twelfth aspect to the sixteenth aspect, a tip of the vibration member in a direction away from the fixed member is chamfered.

In an eighteenth aspect, in the vibration detector according to any one of the twelfth aspect to the seventeenth aspect, the fixed member, the fixed end beam member, the vibration member, and the strain detection member are bonded to each other to form a single body.

In a nineteenth aspect, in the vibration detector according to any one of the twelfth aspect to the eighteenth aspect, the vibration member further includes: a weight member at a position: symmetrical with respect to the fixed end beam member in the second direction; and closer to a tip of the vibration member than the one end of the fixed end beam member in the first direction.

In a twentieth aspect, in the vibration detector according any one of the twelfth aspect to the nineteenth aspect, the fixed end beam member has one or more openings.

In a twenty-first aspect, in the vibration detector according to any one of the twelfth aspect to the twentieth aspect, the vibration member has a cantilever structure having: one end connected to the fixed end beam member; and another end as a free end.

In a twenty-second aspect, a sound wave detector includes the vibration detector according to any one of the twelfth aspect to the twenty-first aspect.

In a twenty-third aspect, a microphone includes the vibration detector according to any one of the twelfth aspect to the twenty-first aspect.

In a twenty-fourth aspect, a wearable device includes the vibration detector according to any one of the twelfth aspect to the twenty-first aspect.

In a twenty-fifth aspect, a vibration detector includes: a vibration member to vibrate in a thickness direction; a fixed end beam member connected to the vibration member at one end of the fixed end beam member in a first direction; a fixed member connected to another end of the fixed end beam member in the first direction; and a strain detection member on at least one of the fixed end beam member or the vibration member and to detect strain of the vibration member. A length of the another end in a second direction perpendicular to the first direction and the thickness direction is shorter than a length of one side of the vibration member in the second direction, the one side of the vibration member is opposed to the fixed member in the first direction.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. A vibration detector comprising:
a vibration member to vibrate in a thickness direction;
a fixed end beam member connected to the vibration member at one end of the fixed end beam member in a first direction;
a fixed member connected to another end of the fixed end beam member in the first direction; and
a strain detection member on at least one of the fixed end beam member or the vibration member and configured to detect strain of the vibration member,
wherein a length of the one end in a second direction perpendicular to the first direction and the thickness direction is shorter than a length of one side of the vibration member in the second direction,
the one side of the vibration member is opposed to the fixed member in the first direction.

2. The vibration detector according to claim 1, including:
multiple vibration members including the vibration member; and
multiple fixed end beam members including the fixed end beam member,
wherein a total length of the one end of the fixed end beam member of the multiple fixed end beam members is shorter than a length of the vibration member opposed to the fixed member.

3. The vibration detector according to claim 1,
wherein the strain detection member covers both of the fixed end beam member and the vibration member.

4. The vibration detector according to claim 1,
wherein the strain detection member includes a piezoelectric film to convert a vibration of the vibration member into an electronic signal.

5. The vibration detector according to claim 1,
wherein the strain detection member is asymmetrical with respect to a center of the fixed end beam member in the second direction.

6. The vibration detector according to claim 1,
wherein a tip of the vibration member in a direction away from the fixed member is chamfered.

7. The vibration detector according to claim 1,
wherein the fixed member, the fixed end beam member, the vibration member, and the strain detection member are bonded to each other to form a single body.

8. The vibration detector according to claim 1,
wherein the vibration member further includes:
a weight member at a position:
symmetrical with respect to the fixed end beam member in the second direction; and
closer to a tip of the vibration member than the one end of the fixed end beam member in the first direction.

9. The vibration detector according to claim 1,
wherein the fixed end beam member has one or more openings.

10. The vibration detector according to claim 1,
wherein the vibration member has a cantilever structure having:
one end connected to the fixed end beam member; and
another end as a free end.

11. A sound wave detector comprising the vibration detector according to claim 1.

12. A microphone comprising the vibration detector according to claim 1.

13. A wearable device comprising the vibration detector according to claim 1.

14. A vibration detector comprising:
a vibration member to vibrate in a thickness direction;
a fixed end beam member connected to the vibration member at one end of the fixed end beam member in a first direction;
a fixed member connected to another end of the fixed end beam member in the first direction; and
a strain detection member on at least one of the fixed end beam member or the vibration member and configured to detect strain of the vibration member,
wherein a length of the another end in a second direction perpendicular to the first direction and the thickness direction is shorter than a length of one side of the vibration member in the second direction,
the one side of the vibration member is opposed to the fixed member in the first direction.
